(19) United States
(12) Patent Application Publication
(10) Pub. No.: US 2011/0013234 A1
(43) Pub. Date: Jan. 20, 2011

(54) IMAGE READING DEVICE AND IMAGE FORMING APPARATUS

(75) Inventors: Kaoru TAKAHASHI, Kanagawa (JP); Shusaku YOKOTA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/726,383

(22) Filed: Mar. 18, 2010

(30) Foreign Application Priority Data
Jul. 16, 2009 (JP) 2009-168167

(51) Int. Cl. H04N 1/04

(52) U.S. Cl. 358/474

(57) ABSTRACT

An image reading device includes: a moving body that is disposed so as to be movable with respect to an image reading device body along a reading portion; a light emitting component that is disposed in the moving body and comprises a plurality of point light sources that are arranged in one row in a substantially orthogonal direction with respect to a moving direction of the moving body; and a light guide body that is disposed adjacent to the light emitting component in the moving body, is placed so as to guide light from the light emitting component to the reading portion, and transmits some light reflected from the reading portion.

### CROSS-REFERENCE TO RELATED APPLICATIONS

This application is based on and claims priority under 35 USC 119 from Japanese Patent Applications No. 2009-168167 filed on Jul. 16, 2009.

### BACKGROUND

### Technical Field

The present invention relates to an image reading device and an image forming apparatus.

### SUMMARY

An image reading device pertaining to a first aspect of the present invention includes: a moving body that is disposed so as to be movable with respect to an image reading device body along a reading portion; a light emitting component that is disposed in the moving body and comprises a plurality of point light sources that are arranged in one row in a substantially orthogonal direction with respect to a moving direction of the moving body; and a light guide body that is disposed adjacent to the light emitting component in the moving body, is placed so as to guide light from the light emitting component to the reading portion, and transmits some light reflected from the reading portion.

### BRIEF DESCRIPTION OF THE DRAWINGS

Exemplary embodiments of the present invention will be described in detail based on the following figures, wherein:

FIG. 1 is a general diagram showing the overall configuration of an image forming apparatus pertaining to an exemplary embodiment;

FIG. 2 is a general diagram showing the configuration of an image forming unit pertaining to the exemplary embodiment;

FIG. 3 is a general diagram showing the configuration of an image reading device pertaining to the exemplary embodiment;

FIG. 4 is a general diagram showing the configuration of a light irradiation unit pertaining to the exemplary embodiment;

FIG. 5 is a perspective diagram showing the configuration of the light irradiation unit pertaining to the exemplary embodiment;

FIG. 6 is a perspective diagram showing the configuration of each configural part of the light irradiation unit pertaining to the exemplary embodiment;

FIG. 7 is a perspective diagram showing the configuration of a bracket and a light irradiation component pertaining to the exemplary embodiment;

FIG. 8 is a perspective diagram showing a state of attachment where the light irradiation component is attached to the bracket pertaining to the exemplary embodiment;

FIG. 9 is a perspective diagram showing a state of detachment where the bracket pertaining to the exemplary embodiment is detached from a first carriage;

FIG. 10 is a side diagram showing a state of detachment where the bracket pertaining to the exemplary embodiment is detached from the first carriage;

FIG. 11 is a side diagram showing a state where the bracket pertaining to the exemplary embodiment is in the middle of being attached to the first carriage;

FIG. 12 is a side diagram showing a state of attachment where the bracket pertaining to the exemplary embodiment is attached to the first carriage;

FIG. 13 is a plan diagram showing a state where the light irradiation unit is positioned in an initial position in a reading component of the image reading device pertaining to the exemplary embodiment;

FIG. 14 is a general diagram showing a state where the light irradiation unit is positioned in the initial position in the image reading device pertaining to the exemplary embodiment;

FIG. 15 is a plan diagram showing the configuration of the light irradiation unit pertaining to the exemplary embodiment; and

FIG. 16 is a perspective diagram showing the configuration of the image forming apparatus pertaining to the exemplary embodiment.

### DETAILED DESCRIPTION

Next, one example of an exemplary embodiment pertaining to the present invention will be described on the basis of the drawings.

### (Configuration of Image Forming Apparatus Pertaining to Present Exemplary Embodiment)

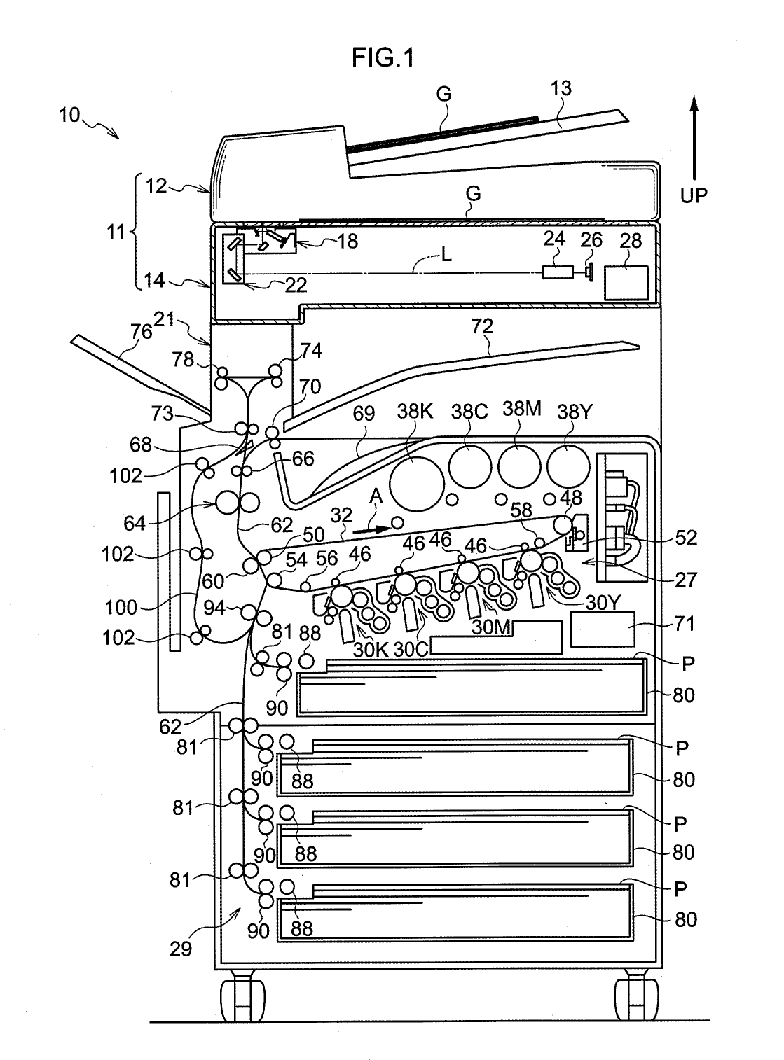

First, the configuration of an image forming apparatus 10 pertaining to the present exemplary embodiment will be described. FIG. 1 is a general diagram showing the configuration of the image forming apparatus 10 pertaining to the present exemplary embodiment.

The image forming apparatus 10 is, as shown in FIG. 1, equipped with an image reading device 11 that reads an image of a document G and an image recording device 21 that records an image on a recording medium P such as paper sheets. The image reading device 11 is placed in the upper portion of the image forming apparatus 10, and the image recording device 21 is placed in the lower portion of the image forming apparatus 10. Arrow UP shown in the drawing represents up in a vertical direction.

The image reading device 11 is configured to read an image of the document G and convert the image it has read into image signals. The image recording device 21 is configured to record an image on the recording medium P on the basis of the image signals that the image reading device 11 has converted. Below, the specific configurations of the image reading device 11 and the image recording device 21 will be described.

(Configuration of Image Recording Device 21 Pertaining to Present Exemplary Embodiment)

First, the configuration of the image recording device 21 pertaining to the present exemplary embodiment will be described.

The image recording device 21 is, as shown in FIG. 1, equipped with plural recording medium housing components 80 in which the recording medium P such as paper sheets is housed, an image forming section 27 that forms an image on the recording medium P, a conveyance section 29 that conveys the recording medium P from the plural recording medium housing components 80 to the image forming section 27, a first discharge component 69, a second discharge component 72 and a third discharge component 76 to which the recording medium P on which an image has been formed by the image forming section 27 is discharged, and a control component 71 that controls the operation of each portion of the image recording device 21.

The image forming section 27 is equipped with image forming units 30Y, 30M, 30C and 30K that form toner images of each color of yellow (Y), magenta (M), cyan (C) and black (K), an intermediate transfer belt 32 that serves as one example of an intermediate transfer body onto which the toner images that have been formed by the image forming units 30Y, 30M, 30C and 30K are transferred, first transfer rolls 46 that serve as one example of first transfer members for transferring the toner images that have been formed by the image forming units 30Y, 30M, 30C and 30K onto the intermediate transfer belt 32, a second transfer roll 60 that serves as one example of a second transfer member for transferring the toner images that have been transferred onto the intermediate transfer belt 32 by the first transfer rolls 46 from the intermediate transfer belt 32 to the recording medium P, and a fixing device 64 for fixing to the recording medium P the toner images that have been transferred from the intermediate transfer belt 32 to the recording medium P by the second transfer roll 60.

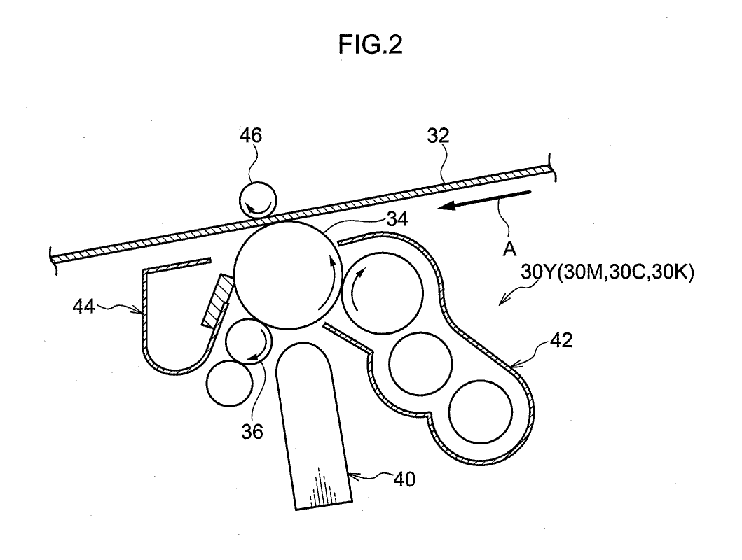

The image forming units 30Y, 30M, 30C and 30K are arranged in the vertical direction center portion of the image recording device 21 in a state where they are slanted with respect to the horizontal direction. Further, each of the image forming units 30Y, 30M, 30C and 30K has, as shown in FIG. 2, a photoconductor drum 34 that rotates in one direction (a counter-clockwise direction in FIG. 1) as an image holding member that holds the toner image that has been formed thereon.

Around each photoconductor drum 34, there are, in order from the upstream side in the direction of rotation of the photoconductor drum 34, disposed a charge device 36 that charges the photoconductor drum 34, an exposure device 40 that exposes the photoconductor drum 34 that has been charged by the charge device 36 to light to thereby form an electrostatic latent image on the photoconductor drum 34, a developing device 42 that develops the electrostatic latent image that has been formed on the photoconductor drum 34 by the exposure device 40 to thereby form a toner image, and a removal device (cleaning device) 44 that removes toner remaining on the photoconductor drum 34 after the toner image that has been formed on the photoconductor drum 34 has been transferred onto the intermediate transfer belt 32.

The exposure device 40 is configured to form the electrostatic latent image on the basis of image signals that have been sent from the control component 71 (see FIG. 1). As the image signals that are sent from the control component 71, there are image signals that have been generated by the image reading device 11 and image signals that have been acquired from an external device.

The intermediate transfer belt 32 is, as shown in FIG. 1, placed on the upper side of the image forming units 30Y, 30M, 30C and 30K and is wrapped with a predetermined tension around a drive roll 48 that applies drive force to the intermediate transfer belt 32, an opposing roll 50 that opposes the second transfer roll 60, a tension applying roll 54 that applies tension to the intermediate transfer belt 32, a first driven roll 56 and a second driven roll 58.

Rotational force is applied by the drive roll 48 to the intermediate transfer belt 32 such that the intermediate transfer belt 32 circularly moves in one direction (the direction of arrow A in FIG. 1) while contacting the photoconductor drums 34.

In a position opposing the drive roll 48 across the intermediate transfer belt 32, there is disposed a removal device 52 for removing toner remaining on the intermediate transfer belt 32.

Further, above the intermediate transfer belt 32, there are disposed toner cartridges 38Y, 38M, 38C and 38K that store toner of each color supplied to the developing devices 42 of each color of yellow (Y), magenta (M), cyan (C) and black (K).

The first transfer rolls 46 oppose the photoconductor drums 34 across the intermediate transfer belt 32. The areas between the first transfer rolls 46 and the photoconductor drums 34 are configured to be first transfer positions where the toner images that have been formed on the photoconductor drums 34 are transferred onto the intermediate transfer belt 32.

The second transfer roll 60 opposes the opposing roll 50 across the intermediate transfer belt 32. The area between the second transfer roll 60 and the opposing roll 50 is configured to be a second transfer position where the toner images that have been transferred onto the intermediate transfer belt 32 are transferred onto the recording medium P.

In the conveyance section 29, there are disposed feed rolls 88 that feed the recording medium P housed in each of the recording medium housing components 80, a conveyance path 62 on which the recording medium P that has been fed by the feed rolls 88 is conveyed, and conveyance rolls 81, 90 and 94 that are placed along the conveyance path 62 and convey to the second transfer position the recording medium P that has been fed by the feed rolls 88.

The fixing device 64 is placed on the conveyance direction downstream side of the second transfer position and fixes the toner images that have been transferred at the second transfer position to the recording medium P.

On the conveyance direction downstream side of the fixing device 64, there are disposed conveyance rolls 66 that convey the recording medium P to which the toner images have been fixed. On the conveyance direction downstream side of these conveyance rolls 66, there is disposed a switch member 68 that switches the conveyance path of the recording medium P. On the conveyance direction downstream side of this switch member 68, there are disposed first discharge rolls 70 that discharge to the first discharge component 69 the recording medium P that is conveyed to one side (the right side in FIG. 1) in the conveyance direction that has been switched by the switch member 68.

Further, on the conveyance direction downstream side of the switch member 68, there are disposed conveyance rolls 73 that convey the recording medium P that is conveyed to the other side (the upper side in FIG. 1) in the conveyance direction that has been switched by the switch member 68, second discharge rolls 74 that discharge to the second discharge component 72 the recording medium P that is conveyed by the conveyance rolls 73, and third discharge rolls 78 that discharge to the third discharge component 76 the recording medium P that is conveyed by the conveyance rolls 73.

On the side of the fixing device 64, there is formed an inverted conveyance path 100 on which is conveyed the recording medium P that has been inverted by reversely rotating the conveyance rolls 73. On the inverted conveyance path 100, plural conveyance rolls 102 are disposed along the inverted conveyance path 100. The recording medium P that has been conveyed by these conveyance rolls 102 is again fed to the second transfer position by the conveyance rolls 94.

Next, image formation operation of forming an image on the recording medium P in the image recording device 21 pertaining to the present exemplary embodiment will be described.

In the image recording device 21 pertaining to the present exemplary embodiment, the recording medium P that has been fed from any of the plural recording medium housing components 80 is fed to the second transfer position by the conveyance rolls 81, 90 and 94.

In the image forming units 30Y, 30M, 30C and 30K, the exposure devices 40 form electrostatic latent images on the photoconductor drums 34 on the basis of image signals acquired from the image reading device 11 or an external device, and toner images based on those electrostatic latent images are formed. The toner images of each color that have been formed by the image forming units 30Y, 30M, 30C and 30K are superimposed on the intermediate transfer belt 32 at the first transfer positions, whereby a color image is formed. Then, the color image that has been formed on the intermediate transfer belt 32 is transferred onto the recording medium P at the second transfer position.

The recording medium P onto which the toner images have been transferred is conveyed to the fixing device 64, where the toner images that have been transferred are fixed to the recording medium P by the fixing device 64. When an image is to be formed only on one side of the recording medium P, then the recording medium P is discharged to any of the first discharge component 69, the second discharge component 72 and the third discharge component 76 after the toner images have been fixed.

When an image is to be formed on both sides of the recording medium P, then the recording medium P is inverted by the conveyance rolls 73 and fed to the inverted conveyance path 100 after an image has been formed on one side. Moreover, the recording medium P is again fed to the second transfer position by the conveyance rolls 94 from the inverted conveyance path 100 and an image is formed in the same manner as described above on the opposite side, whereby an image is formed on both sides of the recording medium P. As described above, a series of image forming operations is performed.

The configuration of the image recording device 21 is not limited to the above-described configuration and may also, for example, be a direct transfer type image recording device that does not have an intermediate transfer body or an image recording device resulting from an inkjet system; as long as it is an image recording device that is capable of recording an image, it may be an image recording device other than the above-described configuration.

(Configuration of Image Reading Device 11 Pertaining to Present Exemplary Embodiment)

Next, the configuration of the image reading device 11 will be described.

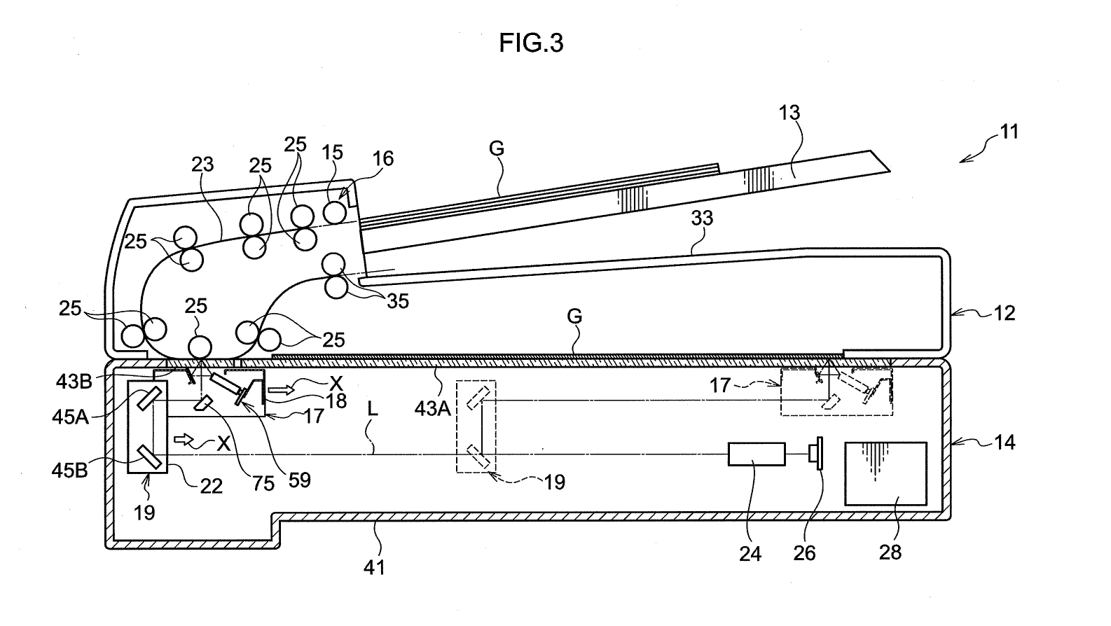

The image reading device 11 is, as shown in FIG. 3, equipped with a document feeding device 12 that conveys the document G and an image reading component 14 that reads an image of the document G conveyed by the document feeding device 12. The document feeding device 12 is placed in the upper portion of the image reading device 11, and the image reading component 14 is placed in the lower portion of the image reading device 11.

The document feeding device 12 is equipped with a document housing component 13 in which the document G is housed, a document discharge component 33 to which the document G is discharged, and a conveyance component 16 that conveys the document G from the document housing component 13 to the document discharge component 33.

The conveyance component 16 is configured to be equipped with a feed roll 315 that feeds the document G housed in the document housing component 13 from the document housing component 13, plural conveyance rolls 25 that convey the document G that has been fed by the feed roll 15 to the conveyance direction downstream side, and discharge rolls 35 that discharge to the document discharge component 33 the document G that has been conveyed by the conveyance rolls 25. The plural conveyance rolls 25 and the discharge rolls 35 are placed along a conveyance path 23 on which is conveyed the document G that has been fed from the document housing component 13.

The image reading component 14 is configured to read images of both a document G that is being conveyed by the document feeding device 12 and a document G that has been placed on a later-described first platen glass 43A, and the image reading component 14 is equipped with a casing 41 in which each configural part is housed.

In the upper portion of this casing 41, there are disposed a first platen glass 43A as one example of a first transmission member on which the document G is placed and which transmits light L for reading an image of that document G and a second platen glass 43B that serves as one example of a second transmission member that transmits light L for reading the document G that is being conveyed by the document feeding device 12.

The document feeding device 12 is attached so as to be openable and closeable with respect to the image reading component 14 and is configured such that the document G is placed on the first platen glass 43A in a state where the document feeding device 12 has been opened.

The image reading component 14 is equipped with a light irradiation unit 17 that irradiates a surface-to-be-read, i.e., a reading portion (image surface) of the document G with the light L, a light guide unit (optical waveguide) 19 that guides the light L that has been reflected by the surface-to-be-read of the document G after the surface-to-be-read G has been irradiated with the light L from the light irradiation unit 17, an imaging lens 24 that images an optical image of the light L that has been guided by the light guide unit 19, and a detection component 26 that detects the optical image that has been imaged by the imaging lens 24.

The light irradiation unit 17 is equipped with a first carriage 18 that serves as one example of a moving body that is movable along the first platen glass 43A, a light irradiation component 59 that is disposed in the first carriage 18 and irradiates the document G with the light L, and a first mirror 75 that is disposed in the first carriage 18 and reflects the light L that has been reflected by the document G. The specific configuration of the light irradiation unit 17 will be described later.

The light guide unit 19 is equipped with a second carriage 22 that serves as one example of another moving body that is movable along the first platen glass 43A, a second mirror 45A that is disposed in the second carriage 22 and reflects the light L that has been reflected by the first mirror 75, and a third mirror 45B that is disposed in the second carriage 22 and reflects the light L that has been reflected by the second mirror 45A toward the imaging lens 24.

The detection component 26 is configured by a photoelectric conversion element such as a charge-coupled device (CCD) image sensor that photoelectrically converts the light L that has been imaged by the imaging lens 24.

The electrical signals that have been obtained by the detection component 26 are sent to an image processing device 28 that is electrically connected to the detection component 26. In the image processing device 28, the electrical signals are image-processed, and the image-processed electrical signals (image signals) are sent to the exposure devices 40 (see FIG. 2) via the control component 71 (see FIG. 1).

(Configuration of Light Irradiation Unit 17)

Next, the configuration of the light irradiation unit 17 will be described.

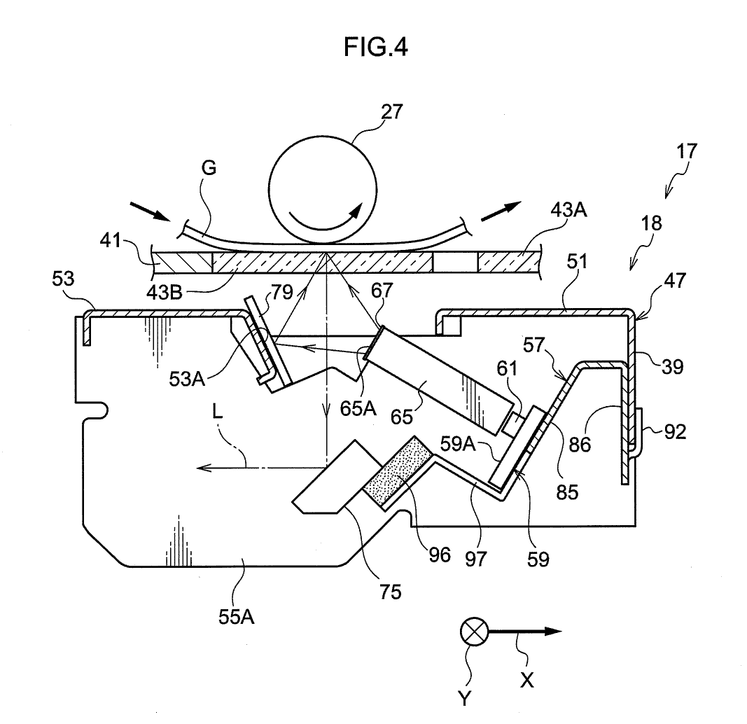

The light irradiation component 17 is, as mentioned above, equipped with the first carriage 18 that serves as one example of a moving body that is movable in the slow scanning direction (the direction of arrow X in FIG. 4) along the first platen glass 43A (see FIG. 4). This first carriage 18 moves along the surface-to-be-read of the document G in a state where the document G has been placed on the first platen glass 43A.

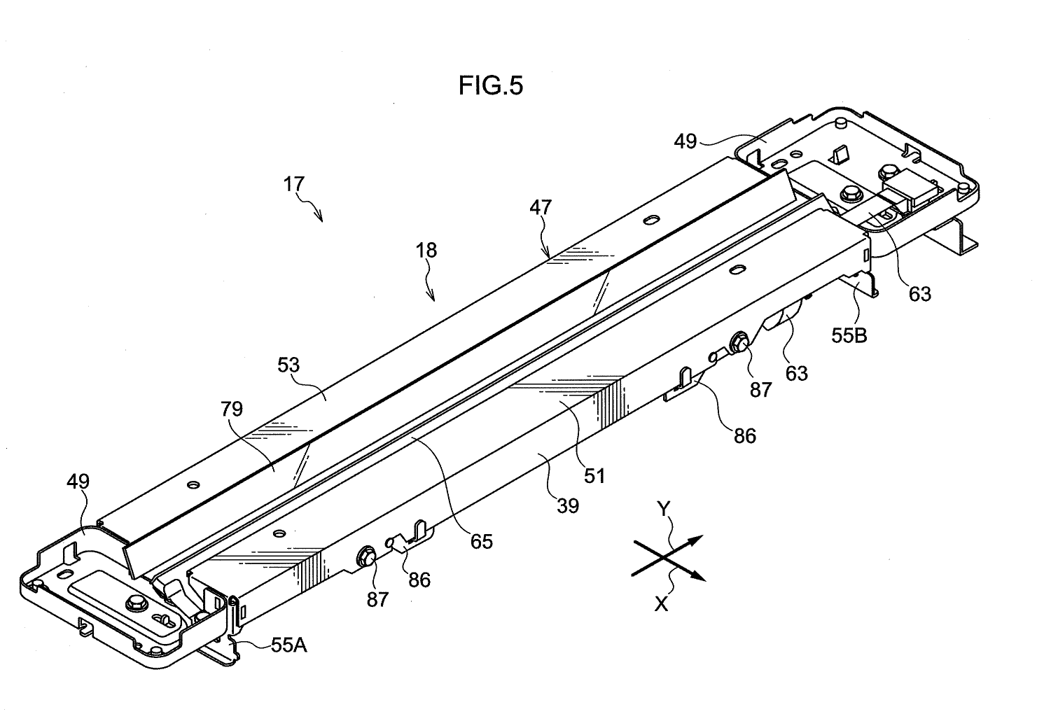

The first carriage 18 is, as shown in FIG. 5, equipped with a carriage body 47 that is formed in an elongate shape along the fast scanning direction (the direction of arrow Y in FIG. 5) and a pair of support members 49 that are placed on both longitudinal direction end portions of the carriage body 47. The pair of support members 49 are supported, so as to be movable in the slow scanning direction (the direction of arrow X in FIG. 5) along the first platen glass 43A, on a frame (not shown) that is disposed in the casing 41 (see FIG. 3) of the image reading component 14. The carriage body 47 and the pair of support members 49 are formed from sheet metal, for example.

The carriage body 47 is equipped with: a pair of side plates 55A and 55B that are placed opposing each other an interval apart from each other in the fast scanning direction (the direction of arrow Y in FIG. 5); and a side wall 39, a first upper wall 51 and a second upper wall 53 that are placed between the side plate 55A and the side plate 55B and are formed integrally with the side plate 55A and the side plate 55B.

The first upper wall 51 and the second upper wall 53 are placed an interval apart from each other in the slow scanning direction (the direction of arrow X in FIG. 5) and are formed in elongate shapes along the fast scanning direction (the direction of arrow Y in FIG. 5). Further, the first upper wall 51 and the second upper wall 53 are configured to oppose the second platen glass 43B when reading an image of the document G that is conveyed through the document feeding device 12 and to oppose the first platen glass 43A when reading an image of the document G that has been placed on the first platen glass 43A.

One slow scanning direction end portion of the second upper wall 53 on the first wall 351 side is folded such that a slanted surface 53A is formed (see FIG. 4).

The interval between the side plates 55A and 55B in the fast scanning direction is larger than the width of an image formation area of the document G (see FIG. 1) in the fast scanning direction.

Further, as shown in FIG. 4, the light irradiation component 59 that irradiates the surface-to-be-read of the document G with the light L is attached to the side wall 39 of the first carriage 18 via a bracket 57 that serves as one example of an attachment member that is attached to the first carriage 18 so as to be attachable and detachable independent of other parts (e.g., a later-described light guide member 65) that have been attached to the first carriage 18. The specific structure by which the light irradiation component 59 is attached to the first carriage 18 will be described later.

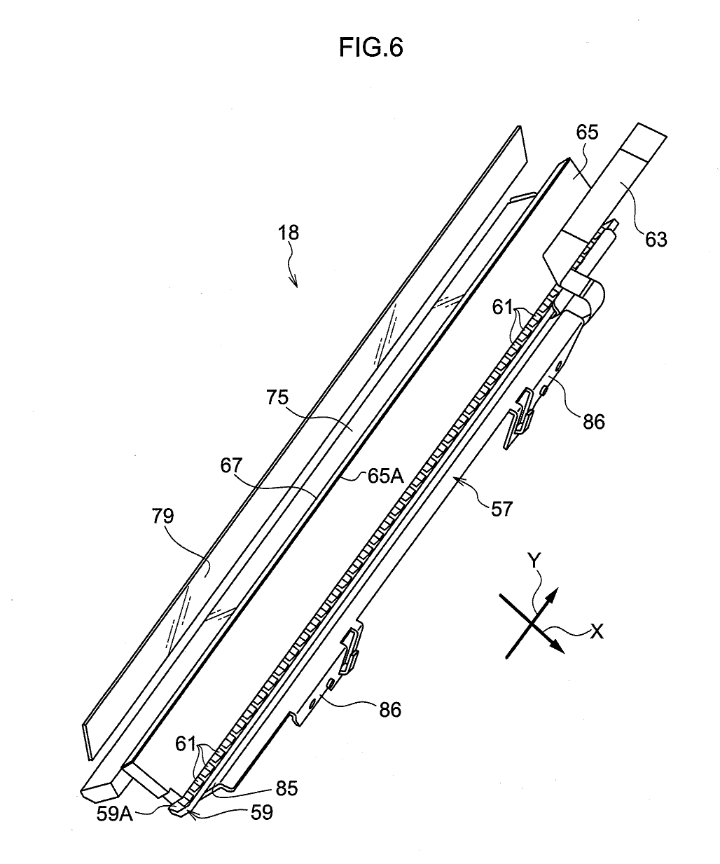

The light irradiation component 59 is, as shown in FIG. 6, configured to be equipped with a circuit board 59A that extends along the fast scanning direction (the direction of arrow Y in FIG. 6) and light emitting elements 61 that serve as one example of light emitting components that emit light toward the surface-to-be-read of the document G. These light emitting elements 61 are placed on the circuit board 59A at constant intervals along the fast scanning direction.

As the light emitting elements 61, for example, light emitting diode (LED) elements are used. The circuit board 59A is supplied with power from the control component 71 (see FIG. 1) via a flexible substrate 63 that is connected to one longitudinal direction end portion of the circuit board 59A.

The plural light emitting elements 61 are not limited to being placed at constant intervals and may also be placed such that the intervals are made narrower on both longitudinal direction end portions of the circuit board 59A than in the longitudinal direction center portion.

Further, the light emitting elements 61 are not limited to LEDs; organic electroluminescence (EL) elements, inorganic EL elements or other light emitting elements may also be applied.

As shown in FIG. 4, the bracket 57 slants with respect to the first platen glass 43A and the second platen glass 43B and supports the light emitting elements 61, and the light L that has been emitted from the light emitting elements 61 toward the document G is made incident from a diagonal direction with respect to the surface of the document G.

Further, on the side of the light emitting elements 61 from which the light L is emitted, as shown in FIG. 4 and FIG. 6, a light guide member 65 that guides the light L from the light emitting elements 61 to the document G is placed opposing the surfaces of the light emitting elements 61 from which the light L is emitted. The light guide member 65 is formed so as to be elongate in the fast scanning direction, and both fast scanning direction end portions of the light guide member 65 are supported by the side plates 55A and 55B.

The light guide member 65 is placed inside the first carriage 18. Specifically, the light guide member 65 is placed on the lower side of the first upper wall 51 and more on the side of a later-described reflector plate 79 than the side wall 39.

The light guide member 65 is configured by acrylic resin, for example, and is configured to totally reflect inside the light L that has been emitted from the light emitting elements 61 and to guide the light L from the light emitting elements 61 to as far as near the reading position of the document G (see FIG. 1).

The light guide member 65 totally reflects inside thereof the light L as described above, whereby the light guide member 65 allows the light L from the light emitting elements 61 to exit from a light exiting surface 65A on the opposite side of the surface opposing the light emitting elements 61, so that variations in the light quantity distribution at least in the fast scanning direction in the light exiting surface 65A are suppressed.

In order for the light guide member 65 to guide the light L made incident from the light irradiation component 59 as far as near the reading position, it is preferable for the light guide member 65 to be molded with a material where it is difficult for the quantity of light to attenuate. As other materials of the light guide member 65, there are polycarbonate resin, polyimide resin, glass, etc.

A diffuser plate 67 that diffuses the light L that has exited from the light guide member 65 is joined to the light exiting surface 65A of the light guide member 65. The diffuser plate 67 is formed by acrylic resin, for example, and concavo-convexities (a diffraction pattern) that diffuse the light made incident thereon from the light exiting surface 65A of the light guide member 65 are formed in a surface of the diffuser plate 67 from which the light L exits. By changing the shape of this diffraction pattern, the light L exiting from the diffuser plate 67 is shaped into a circular shape or an elliptical shape. As other materials of the diffuser plate 67, there are polycarbonate resin, polyester resin, glass, etc.

In a position away from the diffuser plate 67 in the slow scanning direction, there is placed a reflector plate 79 that reflects some of the light L that has exited from the diffuser plate 67 toward the document G (see FIG. 1). The reflector plate 79 is a mirror body that extends along the fast scanning direction, and the surface of the reflector plate 79 on the opposite side of the surface that reflects the light L is fixed to the slanted surface 53A of the second upper wall 53 (see FIG. 4).

Further, on the lower side of the light guide member 65 and the diffuser plate 67, there is disposed the first mirror 75 that guides the light L that has been reflected by the document G to the second mirror 45A (see FIG. 3) of the second carriage 22. The first mirror 75 is held as a result of both end portions thereof being inserted into hole portions formed in the side plates 55A and 55B (see FIG. 4).

The light irradiation unit 17 is not limited to the above-described configuration and may also be configured by a shape and configural parts other than those described above.

Next, image reading operation of reading an image of the document G in the image reading device 11 pertaining to the present exemplary embodiment will be described.

In the image reading device 11, when an image of the document G that has been placed on the first platen glass 43A is to be read, as shown in FIG. 3, the first carriage 18 of the light irradiation unit 17 and the second carriage 22 of the light guide unit 19 move in a moving direction (the direction of arrow X) at a moving distance ratio of 2:1.

At this time, the surface-to-be-read of the document G is irradiated with the light L from the light irradiation component 59 of the light irradiation unit 17. Specifically, as shown in FIG. 4, the light L is emitted from the light emitting elements 61 of the light irradiation component 59, and the emitted light L travels through the inside of the light guide member 65 while being totally reflected and is diffused by the diffuser plate 67. Some of the light L that has been diffused by the diffuser plate 67 passes through the second platen glass 43B such that the document G is irradiated therewith, and of the light L that has been diffused by the diffuser plate 67, the light L that has been diffused toward the reflector plate 79 is reflected by the reflector plate 79 and thereafter passes through the second platen glass 43B such that the document G is irradiated therewith. In this manner, in the light irradiation unit 17, the document G is irradiated with the light L from one side (the right side in FIG. 4) and the other side (the left side in FIG. 4) of the slow scanning direction.

The light L with which the document G has been irradiated is reflected by the surface-to-be-read of the document G, is thereafter reflected in the order of the first mirror 75, the second mirror 45A and the third mirror 45B, and is guided to the imaging lens 24. The light L that has been guided to the imaging lens 24 is imaged on a light receiving surface of the detection component 26.

The length of the optical path of the light L from the surface-to-be-read of the document G to the detection component 26 does not change because the moving distance of the second carriage 22 is half the moving distance of the first carriage 18.

The detection component 26 is a one-dimensional sensor and simultaneously processes one line's worth of the document G in the fast scanning direction that intersects the slow scanning direction (the moving direction of the first carriage 18). In the image reading component 14, after reading of one line in this fast scanning direction has ended, the first carriage 18 is moved in the slow scanning direction to read the next line of the document G. Reading of one page ends when this is executed across the entire document G.

When an image of the document G that is conveyed by the document feeding device 12 is to be read, as shown in FIG. 3, the first carriage 18 and the second carriage 22 are positioned in a state where they are stopped in the solid-line reading position shown on one end portion (the left end portion in FIG. 3) of the image reading component 14.

In this reading position, first, the light L that has been reflected by the first line of the conveyed document G is imaged by the imaging lens 24, and an image is detected by the detection component 26. That is, after one line's worth in the fast scanning direction has been simultaneously processed by the detection component 26 that is a one-dimensional sensor, the next one line in the fast scanning direction of the conveyed document G is read. Then, reading of one page of the document G across the slow scanning direction ends when the trailing edge of the document G passes the reading position of the second platen glass 43B.

(Structure by which Light Irradiation Component 59 is Attached to First Carriage 18)

Next, the structure by which the light irradiation component 59 is attached to the first carriage 18 will be described.

The bracket 57 for detachably attaching the light irradiation component 59 to the side wall 39 of the first carriage 18 has, as shown in FIG. 4, a cross section along the slow scanning direction that is formed in a partially inverted L shape in the fast scanning direction, and the bracket 57 is configured from sheet metal that is a plate body.

Specifically, the bracket 57 is configured to be equipped with a support plate 85 that supports the light irradiation component 59 and attachment plates 86 that are formed integrally with the support plate 85 and are attached to the side wall 39 of the first carriage 18.

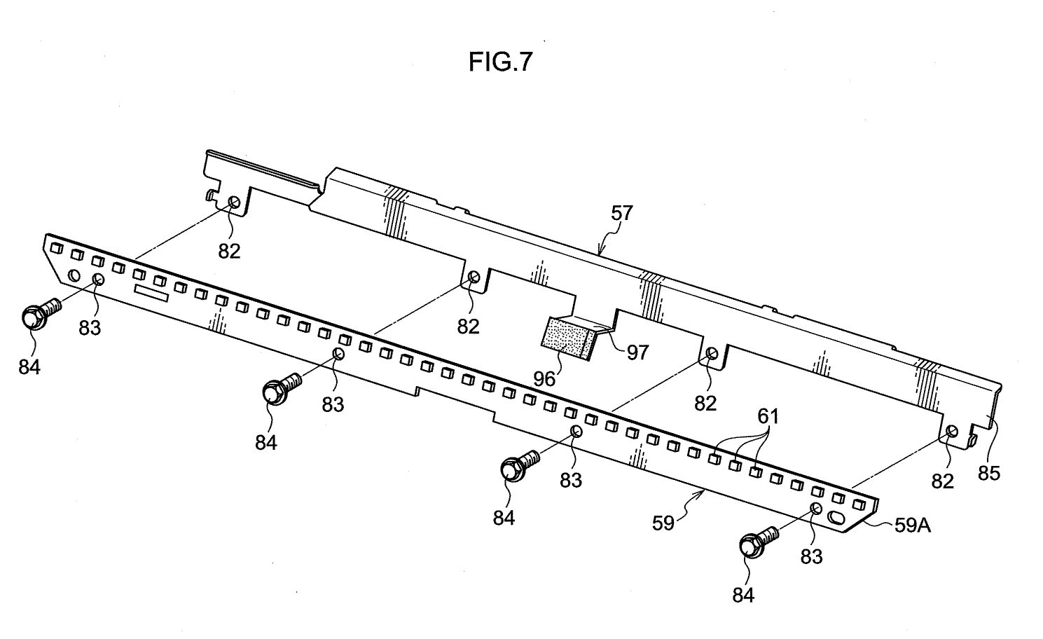

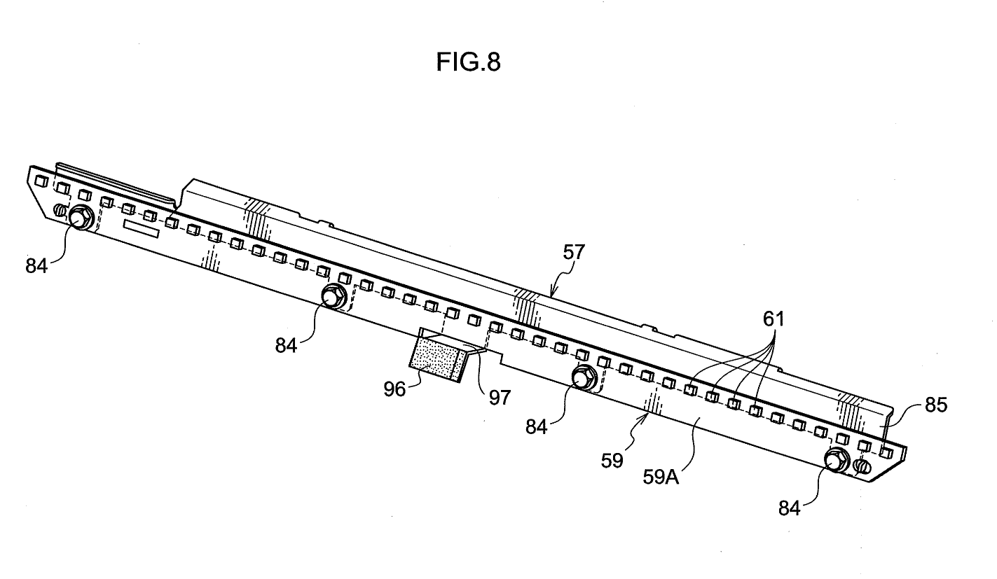

In the support plate 85, as shown in FIG. 7, there are formed plural (in the present exemplary embodiment, four) screw holes 82 that are placed along the longitudinal direction of the support plate 85. In the circuit board 59A of the light irradiation component 59, there are formed plural (in the present exemplary embodiment, four) through holes 83 in correspondence to the screw holes 82. As shown in FIG. 8, bolts 84 that have been inserted through the through holes 83 are screwed into the screw holes 82, whereby the circuit board 59A of the light irradiation component 59 is fixed to the support plate 85.

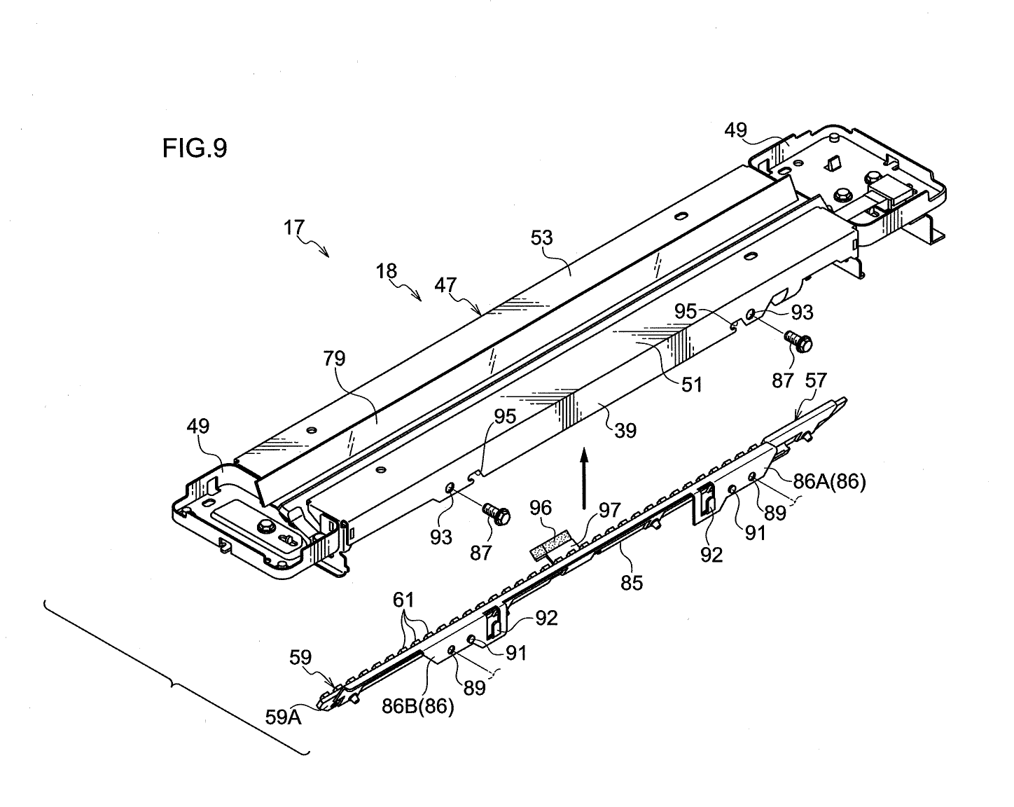

The attachment plates 86 are configured to be equipped with an attachment plate 86A that is placed on one longitudinal direction end side (the upper right side in FIG. 9) of the support plate 85 and an attachment plate 86B that is placed on the other longitudinal direction end side (the lower left side in FIG. 9) of the support plate 85.

On the attachment plates 86A and 86B, there are respectively formed claw portions 92 that serve as one example of regulation members that regulate the movement of the bracket 57 toward other parts (e.g., the light guide member 65) when attaching and detaching the bracket 57.

The claw portions 92 formed on the attachment plates 86A and 86B are respectively placed on the longitudinal direction center side of the bracket 57. That is, the claw portions 92 formed on the attachment plates 86A and 86B are formed on the attachment plate 86B side of the attachment plate 86A and on the attachment plate 86A side of the attachment plate 86B.

The claw portions 92 respectively project upward from the lower end portions of the attachment plates 86A and 86B so that the side wall 39 of the first carriage 18 is inserted between the two claw portions 92 and the attachment plates 86A and 86B from the distal end portions of the claw portions 92.

The side wall 39 that has been inserted between the two claw portions 92 and the attachment plates 86A and 86B strikes the proximal end portions of the claw portions 92 such that further insertion thereof is regulated.

Further, the side wall 39 that has been inserted between the two claw portions 92 and the attachment plates 86A and 86B is sandwiched by the two claw portions 92 and the attachment plates 86A and 86B such that movement of the bracket 57 in the thickness direction of the attachment plates 86A and 86B (movement toward the light guide member 65 in FIG. 4) is regulated.

In the state where the side wall 39 has been inserted between the two claw portions 92 and the attachment plates 86A and 86B, movement of the bracket 57 along the longitudinal direction of the side wall 39 is allowed.

Further, on the attachment plates 86A and 86B, convex portions 91 that serve as one example of held portions are respectively formed on the longitudinal direction center portions of the attachment plates 86A and 86B.

In the side wall 39 of the first carriage 18, there are formed notch portions 95 that serve as one example of holding portions that hold the convex portions 91. Open ends of the notch portions 95 are formed in the lower end of the side wall 39, and the notch portions 95 bend toward one longitudinal direction side (the lower left side in FIG. 9) of the side wall 39. Thus, the notch portions 95 are configured to guide the convex portions 91 entering the notch portions 95 from the lower end of the side wall 39 toward the deep sides of the notch portions 95 that are on one longitudinal direction side (the lower left side in FIG. 9) of the side wall 39 such that the bracket 57 moves in the fast scanning direction where regulation by the claw portions 92 is not performed. The convex portions 91 that have been guided to the deep sides of the notch portions 95 are sandwiched from above and below by the inner walls of the notch portions 95 in the deep sides of the notch portions 95 and are held in a state where movement toward one longitudinal direction side of the side wall 39 is regulated. Thus, the bracket 57 is positioned with respect to the side wall 39.

The holding portions are not limited to the notch portions 95 and may also be groove portions or elongate holes, for example; the holding portions may have a configuration other than the notch portions 95 as long as they hold the held portions. Further, the held portions are not limited to the convex portions 91; the held portions may have a configuration other than the convex portions 91 as long as they are held in the holding portions. Further, the notch portions 95 may also be formed in the bracket 57 as the held portions and the convex portions 91 may also be formed on the side wall 39 as the holding portions.

Further, in the side wall 39 of the first carriage 18, there are formed through holes 93 through which bolts 87 are inserted.

In the attachment plates 86A and 86B, screw holes 89 are formed on end sides in the longitudinal direction of the bracket 57 (on the opposite sides of the claw portions 92 across the convex portions 91) in correspondence to the through holes 93. In the state where the convex portions 91 are held in the notch portions 95, the screw holes 89 and the through holes 93 become superimposed. Thus, in the state where the convex portions 91 are held in the notch portions 95, the bolts 87 that have been inserted through the through holes 93 are screwed into the screw holes 89, whereby the attachment plates 86A and 86B are fixed to the side wall 39.

The support plate 85 slants with respect to the attachment plates 86, and when the attachment plates 86 are attached to the side wall 39, the light emitting elements 61 are placed such that they slant with respect to the surface-to-be-read of the document G.

On the longitudinal direction center portion of the support plate 85, there is formed a support portion 97 that supports a vibration suppressing member 96 that contacts the first mirror 75 and is for suppressing vibration of the first mirror 75. This support portion 97 is formed integrally with the support plate 85 and is configured so as to be attached to and detached from the side wall 39 integrally with the bracket 57. As the vibration suppressing member 96, for example, a porous member such as a sponge or an elastic member such as rubber is used.

The bracket 57 is not limited to the above-described configuration and may also be configured by a shape and placement other than those described above. Further, the regulation members are not limited to the claw portions 92 formed on the bracket 57, may also be members formed on the side wall 39, and may also be configured by a shape and placement other than those of the claw portions 92.

Next, attachment operation of attaching the bracket 57 to the side wall 39 of the first carriage 18 will be described.

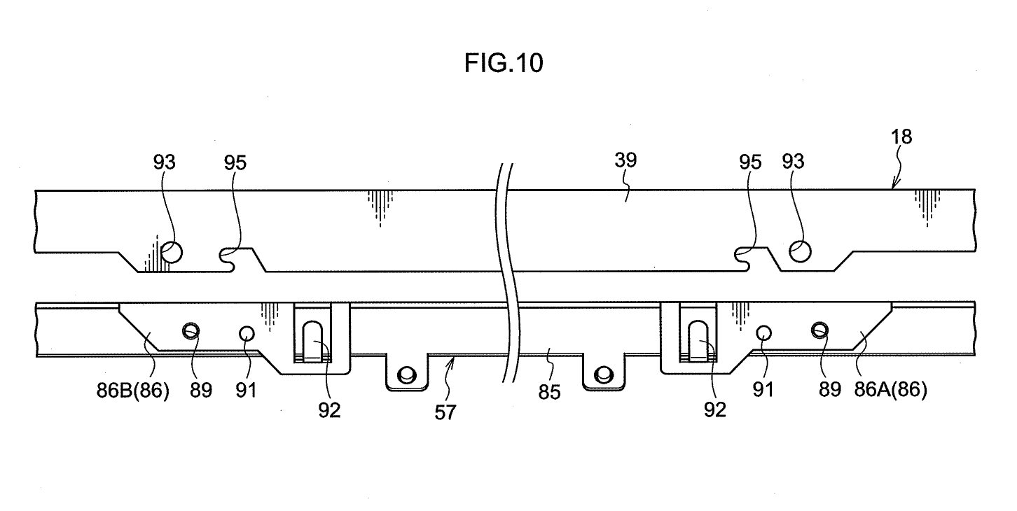

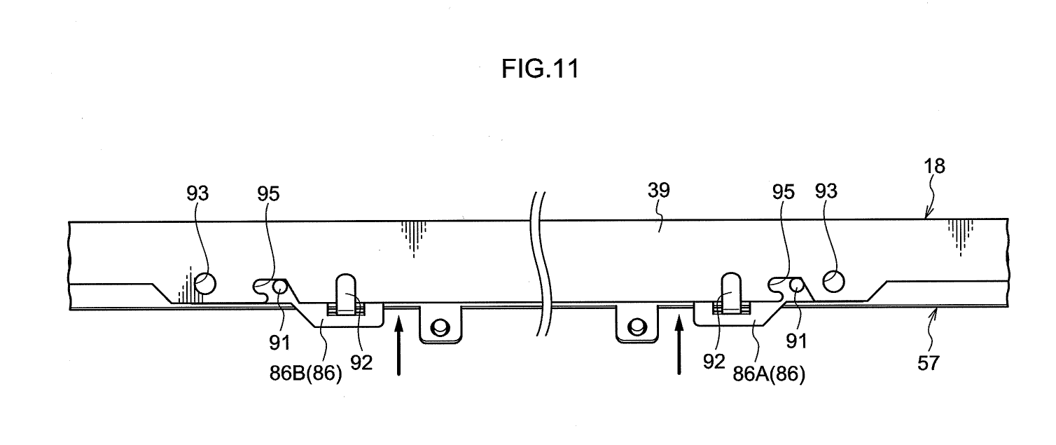

First, as shown in FIG. 10, the bracket 57 in a state where it is detached from the first carriage 18 is moved upward from the lower end of the side wall 39 of the first carriage 18, and, as shown in FIG. 11, the convex portions 91 are inserted into the notch portions 95 and the side wall 39 is inserted between the attachment plates 86A and 386B and the two claw portions 92 (see FIG. 4).

When the convex portions 91 are inserted into the notch portions 95, as shown in FIG. 11, the convex portions 91 strike the inner walls of the notch portions 95 on the deep sides (the upper sides in FIG. 11) in the insertion direction of the convex portions 91 such that movement of the bracket 57 in the insertion direction (upward) is regulated. Further, when the side wall 39 is inserted between the attachment plates 86A and 86B and the two claw portions 92, as shown in FIG. 11, the lower end of the side wall 39 strikes the proximal end portions of the claw portions 92 such that movement of the bracket 57 in the insertion direction (upward) is regulated.

In the state where the side wall 39 has been inserted between the attachment plates 68A and 68B and the two claw portions 92, movement of the bracket 57 along the thickness direction of the attachment plates 86 (the side wall 39) is deterred and movement along the longitudinal direction of the attachment plates 86 (the side wall 39) is allowed.

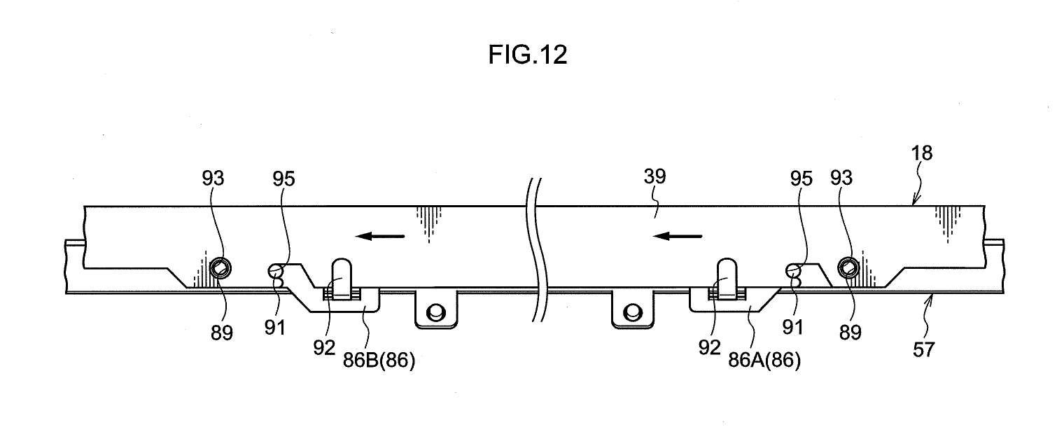

Next, the first carriage 18 is moved toward one longitudinal direction side of the side wall 39 (the left side in FIG. 12). Because of this movement, the convex portions 91 are guided to the deep sides of the notch portions 95, and the convex portions 91 are held on the deep sides of the notch portions 95. In the state where the convex portions 91 are held in the notch portions 95, the through holes 93 and the screw holes 89 become superimposed, and the bolts 87 that have been inserted through the through holes 93 are screwed into the screw holes 89, whereby the attachment plates 86A and 86B are fixed to the side wall 39.

In this manner, when the bracket 57 is to be attached to the side wall 39 of the first carriage 18, movement of the bracket 57 along the thickness direction of the attachment plates 86 (the side wall 39) is regulated, whereby, as shown in FIG. 4, a situation where the light emitting elements 61 contact other parts (e.g., the light guide member 65) located on the thickness direction side of the side wall 39 as seen from the side wall 39 is suppressed.

(Configuration for Suppressing Glare Resulting from Light from Light Emitting Elements 61)

Next, a configuration for suppressing glare resulting from the light from the light emitting elements 61 will be described.

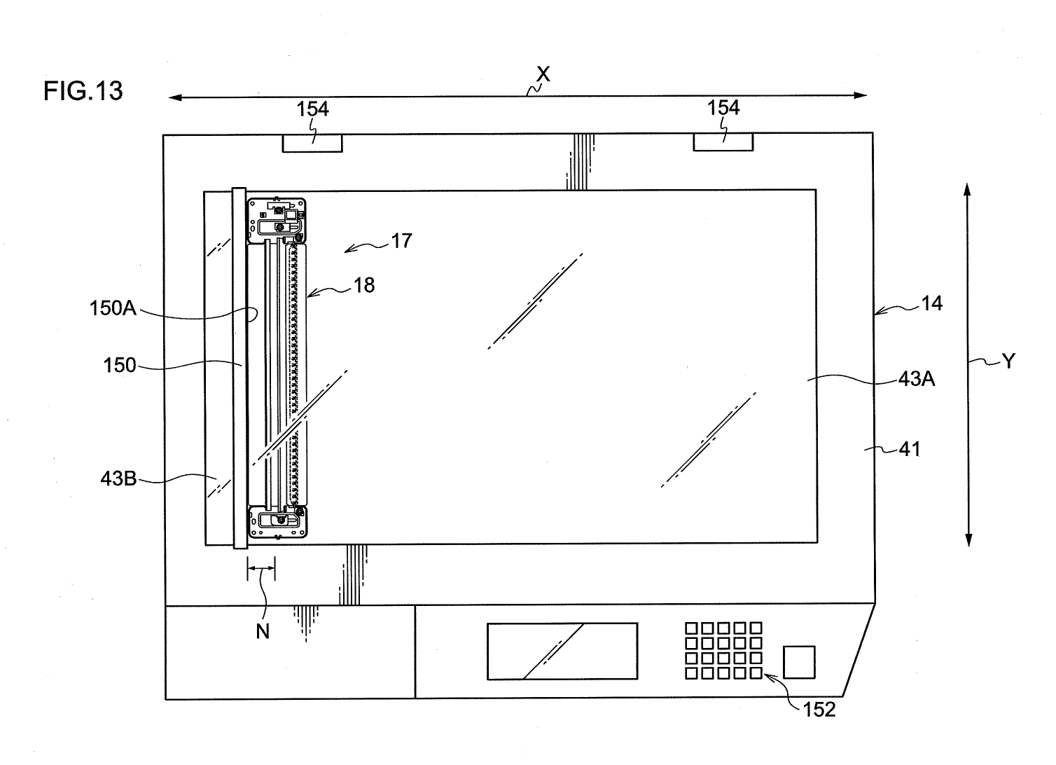

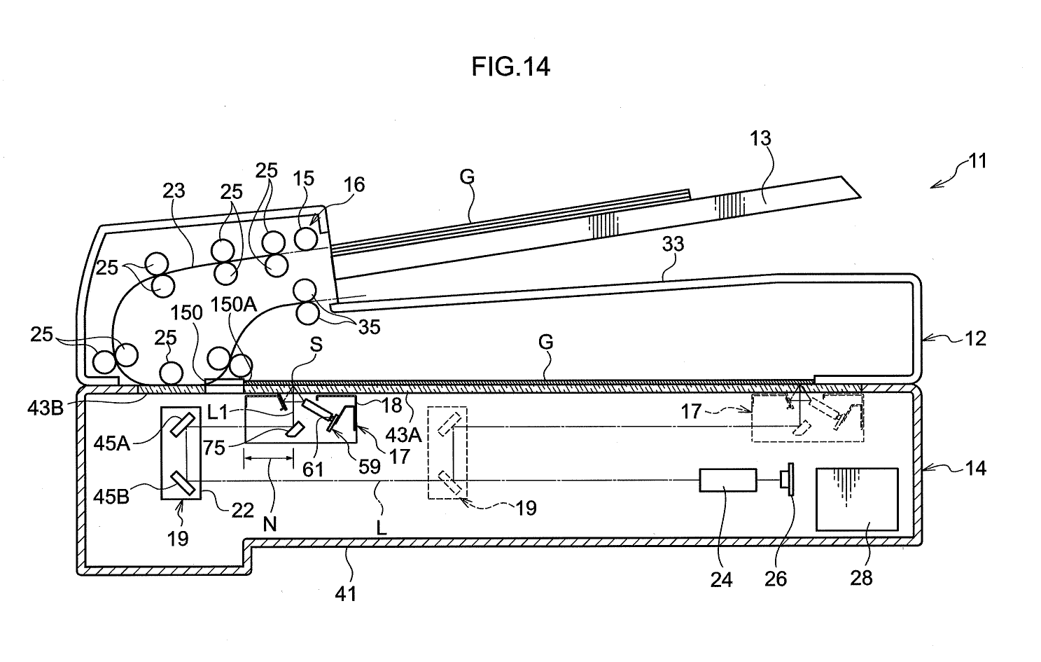

In the present exemplary embodiment, as shown in FIG. 13 and FIG. 14, the light irradiation unit 17 (the first carriage 18) is, in an initial position, placed on one side (the left side in FIG. 13 and FIG. 14) of the casing 41 of the reading component 14 that forms the device body of the image reading device 11. The initial position specifically is a standby position where the light irradiation unit 17 stands by in a state where the image reading device 11 is not performing image reading of the document G.

On one side (the left side in FIG. 13 and FIG. 14) of the casing 41 of the reading component 14 as seen from the first platen glass 43A, there is placed an abutment member 150 having an abutment surface 150A for one end of the document G to abut against in order to place the document G in a predetermined position on the first platen glass 43A.

The initial position of the light irradiation unit 17 is configured to be a position where a length N along the slow scanning direction from an irradiated point S where the document G is irradiated with the light L (an optical axis L1 of the light reflected from the document G) to the abutment surface 150A becomes a predetermined length (e.g., 10 mm).

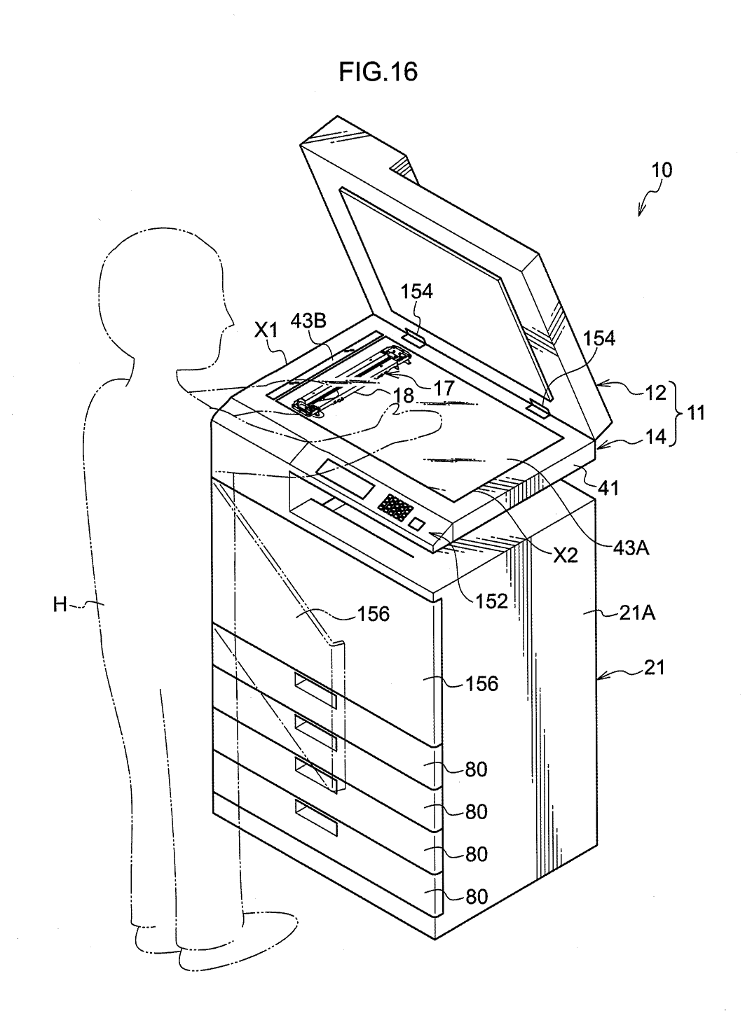

Further, the light irradiation unit 17 is configured such that, in the initial position, when the document feeding device 12 that serves as one example of an opening/closing component that is opened and closed with respect to the reading component 14 (the first platen glass 43A) is closed to a predetermined angle from an opened state (see FIG. 16), the light emitting elements 61 emit light toward the document G, and the detection component 26 detects the light reflected from the document G and detects the width of the document G in the fast scanning direction (the direction of arrow Y in FIG. 13).

The one side (the left side in FIG. 13 and FIG. 14) of the casing 41 is one side in the slow scanning direction and is the side where the light emitting elements 61 begin emitting light with respect to the image surface of the document G when the light emitting elements 61 emit light in order to read an image of the document G that has been placed on the first platen glass 43A.

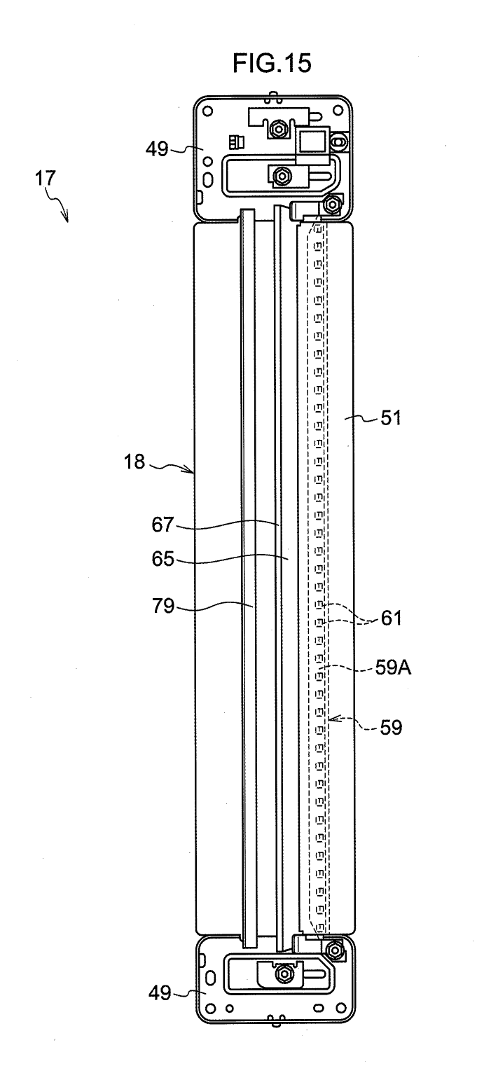

Further, the light emitting elements 61 are, as mentioned above, oriented toward one side (the left side in FIG. 13 and FIG. 14) of the casing 41 as a result of being supported on the support plate 85 of the bracket 57 and emit light upward of the one side of the casing 41. Further, the light emitting elements 61 are, as shown in FIG. 15 and FIG. 4, covered by the first upper wall 51 that serves as one example of a cover member that is placed above the light emitting elements 61.

Moreover, in the present exemplary embodiment, an operation component 152 for an operator H to operate the image forming apparatus 10 (the image reading device 11 and the image recording device 21) is placed on a different side than the one side (the left side in FIG. 13) of the casing 41. Specifically, the operation component 152 is placed on the lower right side in FIG. 13. It suffices for the operation component 152 to be placed on a different side than the one side (the left side in FIG. 13) of the casing 41; thus, for example, the operation component 152 may also be placed on the right side in FIG. 13 that opposes the one side (the left side in FIG. 13) of the casing 41 or on the upper side in FIG. 13.

Further, when the operation component 152 is placed on the upper side or the lower side in FIG. 13, it is desirable for the operation component 152 to be placed further on the right side in FIG. 13 than the initial position.

In the present exemplary embodiment, as shown in FIG. 13 and FIG. 16, on the opposite side (the upper side in FIG. 13) of the side where the operation component 152 is placed, there are placed hinges 154 that support the document feeding device 12 such that the document feeding device 12 is openable and closeable. Thus, the document feeding device 12 is opened with its free end portion being the side where the operation component 152 is placed.

Further, on the side where the operation component 152 is placed, as shown in FIG. 16, an opening/closing component 156 for opening the inside of the image recording device 21 is placed on a casing 21A of the image recording device 21. The opening/closing component 156 is opened such that parts inside the image recording device 21 may be replaced, maintained and inspected.

Further, the recording medium housing components 80 of the image recording device 21 are configured such that they may be pulled out on the side where the operation component 152 is placed. In this manner, the image forming apparatus 10 is configured such that it is easy for the operator H standing on the side where the operation component 152 is placed to perform various operations, replacement, maintenance and inspection.

According to the configuration of the present exemplary embodiment, when the light emitting elements 61 of the light irradiation unit 17 positioned in the initial position emit light, the one side (X1 side of FIG. 16) of the casing 41 is irradiated with the light. Further, even if the light from the light emitting elements 61 were to be diffused upward toward the opposite side (X2 side of FIG. 16) of the one side (X1 side of FIG. 16) of the casing 41 or directly upward, the light would be blocked by the first upper wall 51 (see FIG. 15).

Thus, as shown in FIG. 16, even in the state where the document feeding device 12 has been opened with respect to the reading component 14 (the first platen glass 43A), a situation where the operator H feels that the light from the light emitting elements 61 is glaring is suppressed.

The present invention is not limited to the above-described exemplary embodiments, and various modifications, changes and improvements are possible.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device comprising:
a moving body that is disposed so as to be movable with respect to an image reading device body along a reading portion;
a light emitting component that is disposed in the moving body and comprises a plurality of point light sources that are arranged in one row in a substantially orthogonal direction with respect to a moving direction of the moving body; and
a light guide body that is disposed adjacent to the light emitting component in the moving body, is placed so as to guide light from the light emitting component to the reading portion, and transmits some light reflected from the reading portion.

2. The image reading device according to claim 1, wherein the light emitting component is placed so as to emit light from a diagonal direction having a predetermined angle with respect to the reading portion via the light guide body, and the direction of light emission by the light emitting component is a direction away from a central portion of a front of the image reading device when the moving body is in an initial position.

3. The image reading device according to claim 2, wherein the moving body is disposed so as to move in a left-right direction with respect to the front of the image reading device.

4. The image reading device according to claim 2, further comprising a cover member that is placed above the light emitting component and between the light emitting component and the reading portion and covers the light emitting component.

5. The image reading device according to claim 4, wherein the cover member is formed so as to expose at least part of the light guide body.

6. An image forming apparatus comprising:
an image reading device that includes
a moving body that is disposed so as to be movable with respect to an image reading device body along a reading portion,
a light emitting component that is disposed in the moving body and comprises a plurality of point light sources that are arranged in one row in a substantially orthogonal direction with respect to a moving direction of the moving body,
a light guide body that is disposed adjacent to the light emitting component in the moving body, is placed so as to guide light from the light emitting component to the reading portion, and transmits some light reflected from the reading portion, and
a reading unit that reads an image on the reading portion; and
an image forming component that forms an image on the basis of information of image read by the reading unit.

7. The image forming apparatus according to claim 6, wherein the light emitting component is placed so as to emit the light from a diagonal direction having a predetermined angle with respect to the reading portion via the light guide body, and the direction of light emission by the light emitting component is a direction away from a central portion of a front of the image reading device when the moving body is in an initial position.

8. The image forming apparatus according to claim 7, wherein the moving body is disposed so as to move in a left-right direction with respect to the front of the image reading device.

9. The image forming apparatus according to claim 6, further comprising a cover member that is placed above the light emitting component and between the light emitting component and the reading portion and covers the light emitting component.

10. The image forming apparatus according to claim 9, wherein the cover member is formed so as to expose at least part of the light guide body.

11. An image reading device comprising:
a moving body that is disposed in a device body so as to be movable along a reading portion and, is placed on one side of the device body in an initial position;
a light emitting component that is disposed in a row in a direction intersecting a moving direction of the moving body and emits light to the reading portion toward the one side of the device body; and
a detection component that detects the light emitted from the light emitting component and reflected by the reading portion.

12. The image reading device according to claim 11, wherein
the light emitting component emits light to the reading portion placed above the light emitting component, and
the image reading device further comprises a cover member that is placed above the light emitting component and covers the light emitting component.

13. The image reading device according to claim 11, further comprising an operation component that is placed further on the other side of the device body than the initial position and is for an operator to operate.

14. An image forming apparatus comprising:
the image reading device according to claim 11;
an image recording device that records an image on a recording medium on the basis of an image read by the image reading device.
